(19) United States
(12) Patent Application Publication
(10) Pub. No.: US 2026/0296792 A1
(43) Pub. Date: Oct. 1, 2026

(54) STEEP-ANGLE THERMOPLASTIC ELASTOMER BELTS AND BELTS MADE FROM A COMBINATION OF A RUBBER AND THERMOPLASTIC ELASTOMERS WITH THERMOPLASTIC ABRASIVE AND IMPACT RESISTANT CHEVRON CLEATS FOR MINING AND HEAVY INDUSTRIAL APPLICATIONS

(71) Applicant: ContiTech Deutschland GmbH, Hannover (DE)

(72) Inventors: Sebastian Seibold, Moosinning (DE); Andrey Minkin, Adelebsen (DE); Christel Bäuerle-Müller, Hannoversch Muenden (DE); Stavros Podias, Goettingen (DE); Frank Kantorek, Lehrte (DE); Mohamad Bachir, Medina, OH (US); Donald Brown, Marysville, OH (US)

(73) Assignee: ContiTech Deutschland GmbH, Hannover, OT (DE)

(21) Appl. No.: 19/133,531

(22) PCT Filed: Nov. 7, 2023
(86) PCT No.: PCT/EP2023/081065

§ 371 Date: May 28, 2025

Related U.S. Application Data
(60) Provisional application No. 63/386,283, filed on Dec. 6, 2022.

(51) Int. Cl. B65G 15/34; B65G 15/42; E21F 13/08

(52) U.S. Cl. CPC B65G 15/34; B65G 15/42; E21F 13/083; B65G 2201/045

(57) ABSTRACT

Conveyor belts having a top cover on the carrying side and the bottom cover on the pulley side, where the top cover on the carrying side has a chevron profiling, and where the top cover and the chevron profiling on the carrying side are formed from a thermoplastic elastomer. Also provided are methods for the production of corresponding conveyor belts, the use of respective conveyor belts for conveying of bulk solid materials, wherein the conveyor belt is used at least partially at an angle of inclination of more than 20° and where the bulk solid material is preferably material in hard rock mining or heavy industrial applications, and conveyor belt systems which include respective conveyor belts.

The present invention concerns conveyor belts having a top cover on the carrying side and a bottom cover on the pulley side, where the top cover on the carrying side has a chevron profiling and where the top cover on the carrying side and the chevron profiling is formed from a thermoplastic elastomer or a combination, where a lower part of the top cover consist of a rubber layer and the upper layer with chevron profiling are made of thermoplastic elastomer. In the case of a combination, the bottom cover can be made of a rubber or a thermoplastic elastomer or a combination of it depending on an application case and costs. The present invention further concerns methods for the production of corresponding conveyor belts, the use of respective conveyor belts for conveying particulate material, wherein the conveyor belt is used at least partially at an angle of inclination of more than 20° and where the particulate material is preferably material in hard rock mining or heavy industrial applications, and conveyor belt systems which comprise respective conveyor belts.

### STATE OF THE ART

Conveyor belts are a conventional means to transport large amounts of material over greater distances, such as e.g. coal, clay or ores from the site of mining to a site, where the material is further processed or packaged for transport. As the track, where the material is transported along, is usually not flat over its entire . . . length, the conveyor belt may have to cover ascends, where the material is brought to a higher level.

Conventional rubber belts have a favorable friction to conveyed material, so that the belt can transport the material over inclination angles of up to 15° and in some cases even up to 20° without additional surface adaptation of the belt. To be able to transport material over higher inclination angles, without the material sliding down the belt, it is possible to modify the surface of the conveyor belt with surface structures, which provide hindrance towards sliding. Typical surface structures for this purpose are chevron cleats or similar pattering or textures.

When the surface of the belt is not flat, the patterning thereon is especially vulnerable to mechanical wear, like a cut, rip, tear or abrasion, as material, which is poured onto the belts, inflicts its kinetic energy predominantly on parts of the belts, which stick out from the surface. Therefore, it has to be ensured that the attachment of surface patterning is sufficiently solid to withstand such mechanical wear.

The rubber materials, which are employed for the production of rubber conveyor belts are vulcanized to provide the belt with the required toughness and resilience. Here, it is regularly not possible to attach surface structures such as chevron cleats to a vulcanized flat belt, as rubber materials are notorious as “difficult to bond substrates.” Accordingly, one method to prepare profiled rubber conveyor belts is via the use of profiled heating plates during the vulcanization, by means of which profiles with a height of up to about 15 mm can be prepared. However, when it comes to the production of surfaces with higher or more massive profiles, as is often required in mining or heavy industrial applications, such production is very time and labor intensive.

Another problem, which is associated with regular rubber belts, is their behavior towards sticky materials (e.g. wet clay) and in particular dust, which is transported on the belt. Here, due to e.g. electrostatic attraction, the dust may stick to the belt and removal thereof is difficult even if aids for the removal thereof (such as wipers or brushes) are used. During the transport of the belt back to a position, where new material is applied on the belt, the dust or a remaining sticky material can be detached from the belt due to movement or hits on the belt. This applies in particular as the belt in this stage is usually conveyed upside down to the transport direction of the material to be transported. Accordingly, there is significant spillage and dusting problem with such belts, which, even if significant cleaning effort is made to remove waste material particles from the belt after the transported material has been discharged, cannot be fully avoided.

A yet further problem of conventional rubber conveyor belts is that to provide the required impact resilience and abrasion resistance properties, the rubber has to be provided in a significant thickness, which leads to relatively heavy belts.

A yet further problem of such rubber conveyor belts is the vulcanization, which is necessary to provide the required mechanical strength of the belt. As vulcanization is essentially (irrversible) crosslinking, the material cannot be “recycled” in the regular sense, but can only be “downcycled” to products with lower quality demands or “thermally utilized”. As recyclability is these days becoming more and more important, the necessity to vulcanize rubber in rubber conveyor belts is a big disadvantage.

CN103910164 A discloses a wear-resisting PVG herringbone conveying belt which is prepared from an inner belt carcass structure of and PVG top and bottom covers, which are applied onto the belt carcass, and where the top cover comprises a herringbone patterning. The respective belt had a top cover thickness of 3 to 6 mm and a depth of the patterning of about 3 to 4 mm.

Given the above, there is a need for conveyor belts for the transport of bulk materials such as e.g. ore or coal, where a profiled surface can be created without difficulty and where even the fabrication of cleats with a height of more than 15 mm is possible with minimal production time and labor. The respective desired belts should in addition be lightweight, in that the required mechanical properties can be provided with less material compared to conventional rubber belts, and should be easy to clean. Preferably, in addition, the material to provide the structured top cover of the conveyor belt should also be processable in terms of a true recycling, where the material can be used to prepare new conveyor belts.

The present application addresses these needs.

### DETAILED DESCRIPTION OF THE INVENTION

In the investigations, which are underlying the present invention, it has unexpectedly been disclosed that conveyor belts with a profile on the surface thereof, which have mechanical properties comparable to or even superior than conventional rubber conveyor belts, can be prepared by using a thermoplastic elastomer for the production of the top cover. Respective thermoplastic elastomers can be processed by casting or injection molding, which significantly simplifies the production process. In addition, the surfaces formed from thermoplastic elastomers provide the benefit of being easier to clean, and, due to the “thermoplastic” nature of the elastomer, the material can be remolten at the end of the lifetime of the belts and reprocessed.

Accordingly, in a first aspect, the present invention pertains to a conveyor belt 1, with a top cover 12 on the carrying side and a bottom cover 13 on the pulley side, wherein the covers 12, 13 comprise an elastomeric material and the conveyor belt further comprises a belt core 11a having one or more embedded reinforcement members 11, wherein the conveyor belt 1 on its top cover 12 has a profiling 15-19, which is formed substantially perpendicular Z to the carrying-side top cover 12, wherein the profiling 15-19 is a chevron profiling that has diagonal elements 15 that extend both in the longitudinal direction X and in transverse direction Y of the conveyor belt 1 and which together form a V-shape in pairs, characterized in that the top cover 12 on the carrying side and the chevron profiling is formed from a thermoplastic elastomer. In the chevron profiling, the tip 16 of the V shape can be formed from diagonal elements 15, which a touching each other or where there is only a small gap between diagonal elements 15 or can be formed by an additional element, which is aligned in the longitudinal direction X counter to the conveying direction Q.

In the above, the term “formed from a thermoplastic elastomer” is intended to cover the case where the full top cover 12 and the chevron profiling is formed from a thermoplastic elastomer as well as the case, where a part of the top cover 12 on the carrying side and the chevron profiling is formed from a thermoplastic elastomer.

Accordingly, in its principal configuration, the inventive conveyor belt has a middle belt core, which is composed of a belt core material and one or more embedded reinforcement members, and has a cover on both sides thereon, wherein one of the covers has a patterning and in operation is used as the carrying side of the conveyor belt. If the conveyor belt has only one embedded reinforcement member, it is preferred that the reinforcement member is a fabric, which can provide enforcement in both the running direction of the conveyor belt and the width direction of the belt. If the belts has more than one reinforcement members, the reinforcement members can be one dimensional strands or cords, which in the belt are arranged parallel in the running direction of the belt, or can be multiple fabrics, which in the belt are arranged stacked onto one another. In this configuration, the core body material is usually present between respective fabric plies. In addition, it is possible that the more than one reinforcement members can be provided by a combination of one or more fabrics and one or more stands or cords.

In the belt, the reinforcement member or reinforcement members are embedded into the belt core, which means that at least some of the material of the belt core penetrates into the pores or hollow spaces in the reinforcement members or between different reinforcement members. If the inventive belt has two (or more) reinforcement members, which are stacked over one another in the belt core, it is possible that the belt core material penetrates the fabric only from one side, and that on the other side there is partial penetration only of the material of the covers.

The reinforcement members can be constituted from any suitable material, which includes steel cables, fabrics or polyamide, aramide, polyethylene (e.g. UHMW-polyethylene) cords, ropes or fabrics. The fabrics can be made of polyester, polyamide, cotton or combinations thereof. For example, woven conveyor belts can have woven carcasses that have polyester threads in the warp direction (longitudinal direction) and polyamide threads in the weft direction (transverse direction) (EP fabric). Polyester threads can also be used in both directions (EE fabric) or polyamide threads can be used in both directions (PP fabric). Furthermore, polyester, polyamide and cotton threads can be used in the warp direction and polyamide and cotton threads in the weft direction (EP-B-PB fabric). Because PP fabric stretches a lot in comparative processing and results in EE fabric, EP fabric represents a compromise solution and is the most commonly used reinforcement member in textile belts. Likewise, the conveyor belts can have woven carcasses as reinforcement members that have polyethylene or UHMWE-polyethylene threads in the warp direction and polypropylene threads in the weft direction. Respective reinforcement members are easy to recycle with covers made from a thermoplastic elastomer.

As noted above, the inventive conveyor belts are particularly advantageous for profiling, which has a height of at least 10 mm and in particular at least 15 mm, as belts with such profiling cannot easily be prepared with conventional rubbers. Accordingly, it is preferred that the inventive conveyor belt has a height of the chevron profiling of at least 15 mm, and more preferably in the range of 20 to 50 mm.

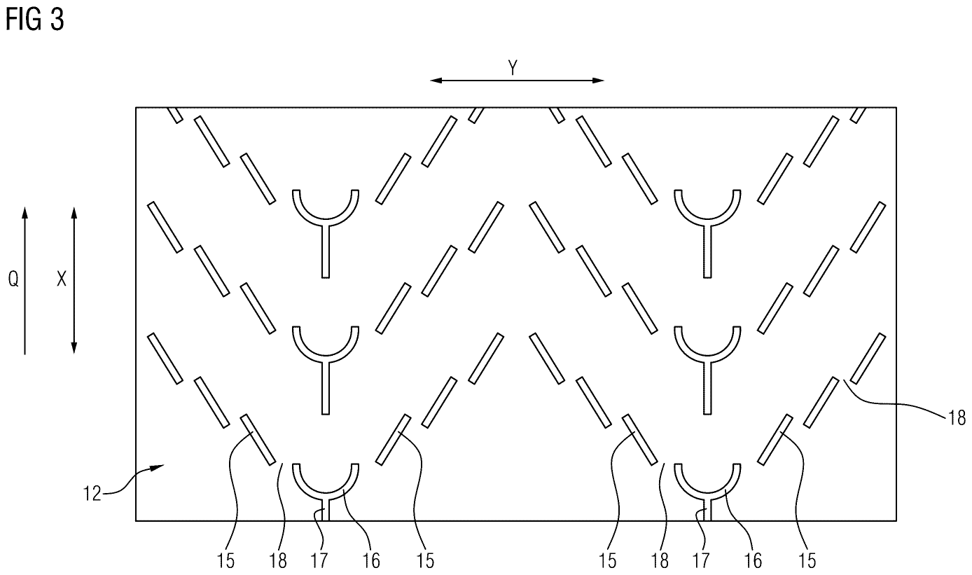

The shape of the profiling is not subject to any relevant restrictions, as long as the profiling is such that the sliding of material, which is transported on the conveyor belt, is hindered when the belt is at a higher inclination angle. Exemplary, but not limiting examples of the shape of the profiling are provided in the pendant FIGS. 3 to 6.

As noted above, the core of the invention is the use of a thermoplastic elastomer as the base material for the top cover or part of it of the carrying side of the belt, which has the chevron profiling. While the specific type of the thermoplastic elastomer is not of particular importance, it has been found that thermoplastic polyurethanes (TPU) and thermoplastic vulcanisates (TPV) (i.e. elastic material, which have crosslinks between individual polymer molecules, but which still can be formed at elevated temperatures), due to their mechanical properties, are particularly suited for the preparation of the top cover. Accordingly, it is preferred if the thermoplastic elastomer in the inventive conveyor belt comprises and preferably is selected from a thermoplastic polyurethane and a thermoplastic vulcanisate.

Particularly suitable thermoplastic polyurethanes are those which are based on a polyether polyol, preferably polytetramethylene glycol, or a polyester polyol as the polyol component. Particularly advantageous polyester polyols are for example adipate-based polyester polyols, in particular in the form of polybutylene adipate, or polycaprolactone-based polyester polyol. To provide the respective thermoplastic polyurethanes, the polyols are reacted with a polyisocyanate or a mixture of polyisocyanates, wherein the polyisocyanate preferably comprises and in one embodiment consists of aromatic polyisocyanates. Particularly preferred aromatic polyisocyanates for the production of thermoplastic polyurethanes for use in the invention include toluene diisocyanate, methylene diisocyanate or mixtures thereof. In addition to polymeric polyols, the thermoplastic polyurethane may also comprise segments resulting from the incorporation of monomeric polyols, in particular α,ω-diols such as 1,4-butane diol.

If the thermoplastic elastomer, which is used in the inventive conveyor belt, is a thermoplastic vulcanisate, it is preferred that the vulcanisate is formed form ethylene-propylene-diene rubber (EPDM) and polypropylene by dynamical vulcanisation of the respective mixture thereof. In such mixtures, the ratio of EPDM and polypropylene is preferably in the range of 60:40 to 40:60 and more preferably about 50:50.

Next to the thermoplastic elastomer, the top cover on the carrying side will in most cases comprise at least one reinforcing filler. As reinforcing fillers carbon black, silica, or lignin with carbon black are preferred. The filler is normally present at a level which is within the range of 20 phr to 80 phr and is more typically present at a level which is within the range of 30 phr to 75 phr. Even more preferably, the filler is present in the top cover 12 at a level which is within the range of 40 phr to 70 phr.

To further strengthen the conveyor belt of the invention, the belt can have one or more further transverse reinforcement elements, also known as breakers, such as e.g. fabric breakers or breakers applied in tires steel cord reinforcements comprising thin steel cables, which are closely arranged to one another.

The chevron profiling in most cases covers at least 50% and preferably from 70% to 95% of the width of the belt. At the edges of the belt in the width direction, there is usually a small gap which is not covered by the profiling, because this facilitates dust isolation in the contact area between a belt and a material feeding- or transfer chute. Furthermore, most of the material to be transported will be around the center and the lack of profile at the edges has no impact on the functionality of the belt.

In addition, it is preferred that the chevron profiling and the top cover (or a part of its thickness) are formed as one piece, i.e. that the chevron profiling is formed as part of the top cover 12. Such one piece can e.g. be easily be produced by extrusion of a thermoplastic elastomer layer on a belt core, followed by imprinting the desired profiling thereon, or could be formed by pouring a molten thermoplastic elastomer in a form having the negative of the desired chevron profile and applying thereon the belt core having the one or more reinforcement members embedded therein. Forming the chevron profiling and the top cover as one piece provides the advantage of reduced manufacturing costs and simplified transport of the conveyor belt.

In the investigations, which are underlying the present invention, it has also been found that thermoplastic elastomers also provide favorable characteristic for use as a bottom cover on the pulley side, such as in particular a low coefficient of friction. Accordingly, conveyor belts having a top cover and bottom cover which are based on thermoplastic elastomers as the rubber constituent, are preferred in this invention. From a cost and recycling perspective, it is particularly preferred if the top cover 12 on the carrying side and the bottom cover 13 on the pulley side are formed from the same thermoplastic elastomer material.

In a further aspect, the present invention pertains to a method for the production of a conveyor belt as described above, wherein the method comprises the following steps:
i) providing one or more reinforcement members 11;
ii) embedding the one or more reinforcement members in a belt core 11a;
iii) applying a top cover 12 on one side of the belt core;
iv) applying a bottom cover 13 on the other side of the belt core;
wherein the top cover 12 is prepared with a chevron profiling and at least the top cover 12 or part of it and the chevron profiling are formed from a thermoplastic elastomer.

The sequence of the steps iii) and iv) is not of critical relevance to the method, and it is not important, which of the layers is attached to the belt core 11a first.

As noted above, the top cover with a chevron profiling can be prepared by extrusion of a flat layer followed by imprinting thereon of the profile, or by pouring a sufficiently fluid thermoplastic elastomer into a form, which has the negative of the chevron profile and cooling the same to provide the consolidated top cover 12. The attachment of the top and bottom covers can be performed e.g. by heat-pressing or by application of an adhesive, by means of which the respective layers are attached to one another.

The inventive conveyor belts provide particular advantages for the transport of particulate material, where the materials have to be elevated to a higher level. In such applications, the chevron profile hinders the particulate material from sliding down the belts, where when the belt is at higher inclination angles. Accordingly, another aspect of the invention concerns a use of the inventive conveyor belt for conveying particulate material, wherein the conveyor belt is used at least partially at an angle of inclination of more than 20° and preferably in the range of 25° to 45°. During the respective use, the thermoplastic elastomer is advantageously used at ambient temperature, respectively, at a temperature, which is sufficiently below the melting temperature of the thermoplastic elastomer e.g. at least 50° C. below this temperature, more preferably at least 65° C. and even more preferably at least 75° C. below melting temperature of the thermoplastic elastomer.

Further, as noted above, thermoplastic elastomers have favorable characteristics for belts, which are subjected to high deformation forces in the course of the transport of heavy items. Accordingly, in a further aspect, the present invention pertains to a use of the inventive conveyor belts for the transport of heavy items and/or bulk solid material, in particular in hard rock mining or heavy industrial applications. Exemplary materials to be transported in such applications include rocks, coal or ores.

In a yet further aspect, the present invention pertains to a use of a thermoplastic elastomer as a cover material for a conveyor belt having a chevron profile for reducing the weight of the conveyor belt. In a yet further aspect, the present invention pertains to a use of a thermoplastic elastomer as a cover material for a conveyor belt having a chevron profile for improving at least one of the impact energy or the cleanability test rating of the conveyor belt. The respective use involves applying a respective cover of a conveyor belt on a belt carcass to provide the conveyor belt.

In a yet further aspect, the present invention pertains to a conveyor belt system, which comprises at least one drive pulley with a motor and one deflection pulley and a conveyor belt as described above.

Finally, in a yet further aspect, the invention pertains to a process of refurbishing a conveyor belt as described above with a new top cover, where the old top cover is removed from the belt core in a first step, e.g. by means of a heated scraper, and a new top cover having a chevron profiling, wherein the new top cover having a chevron profiling are constituted from a thermoplastic elastomer, is applied on the belt core. Preferably, in this method the old top cover is at least in part recycled to provide new top cover of respective refurbished conveyor belts.

Exemplary embodiments and further advantages of the invention are described below in connection with the following figures. These show:

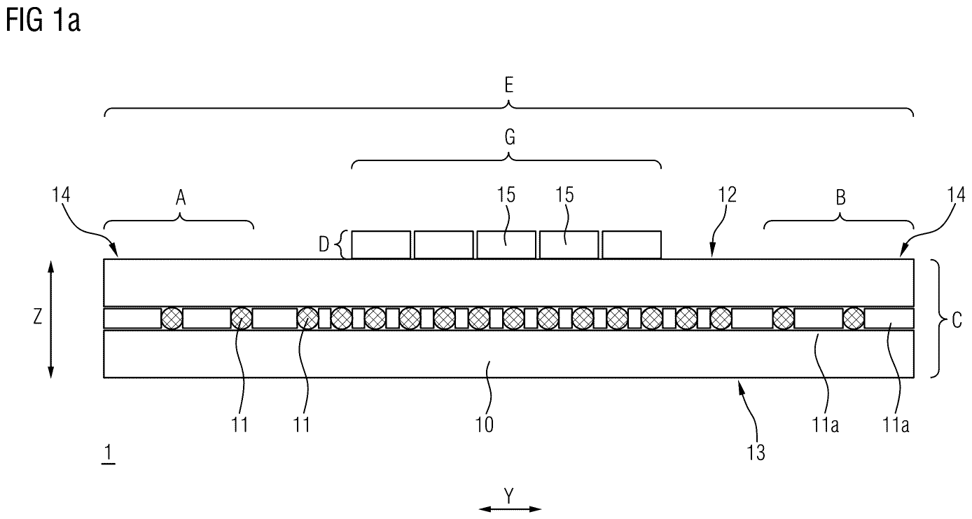

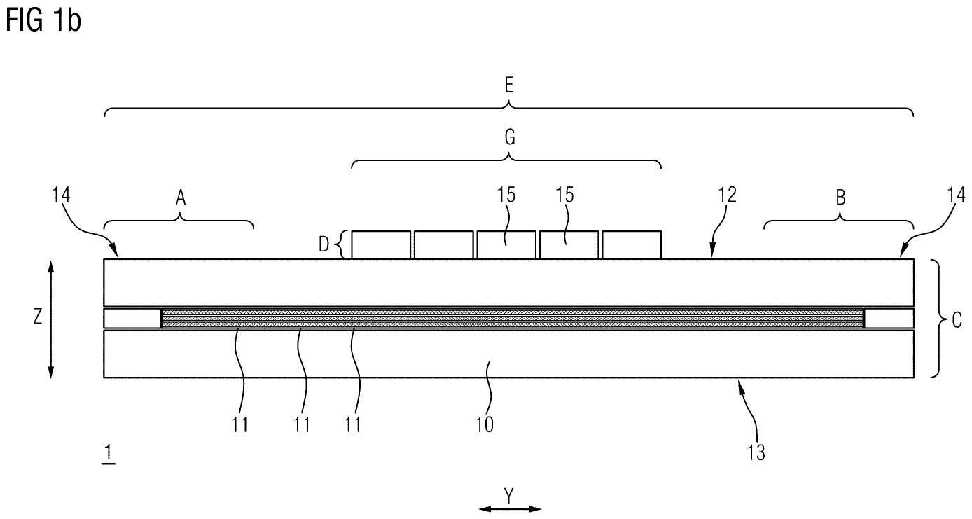

FIGS. 1a and 1b schematic representations of a section through a conveyor belt according to the invention;

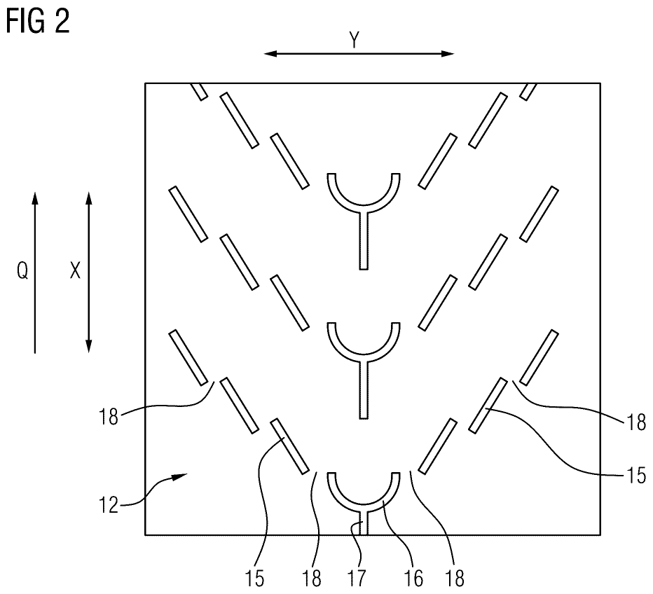

FIG. 2 a schematic plan view of a preferred embodiment of a simply arranged profiling of an inventive conveyor belt;

FIG. 3 a schematic plan view of a preferred embodiment of a double-arranged profiling of a conveyor belt according to the invention;

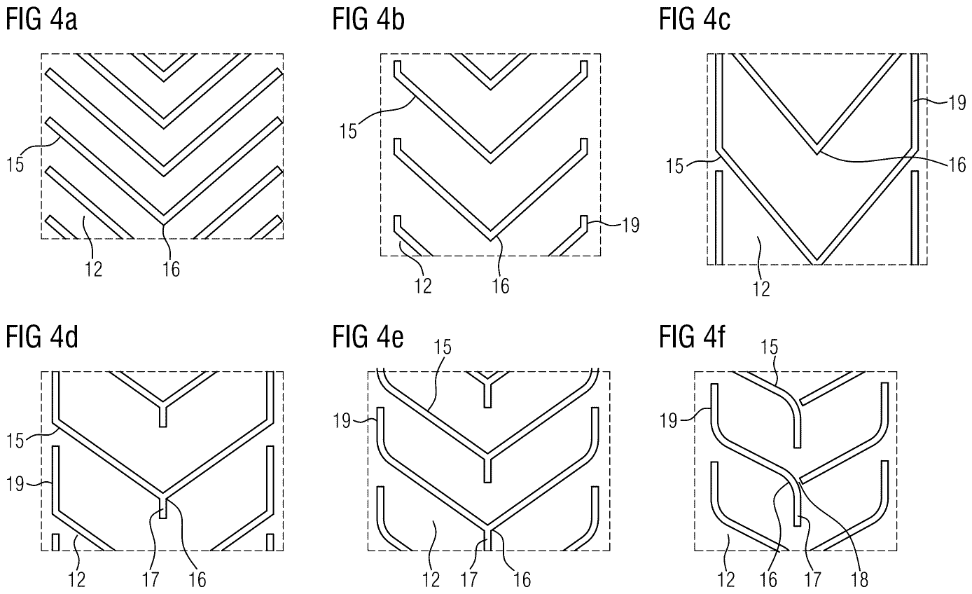

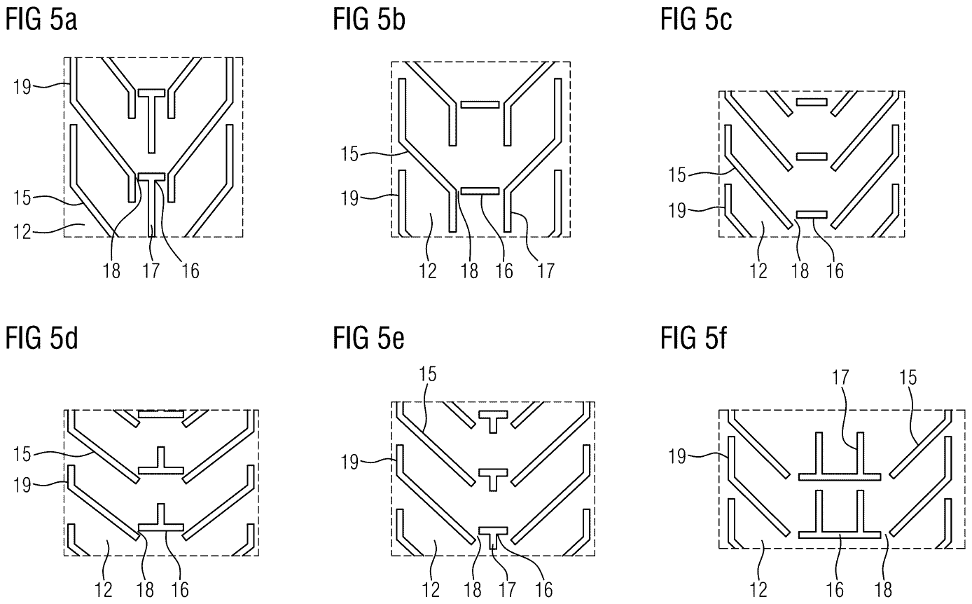

FIGS. 4a to 5f schematic plan views of various embodiments of a simply arranged profiling of an inventive conveyor belt;

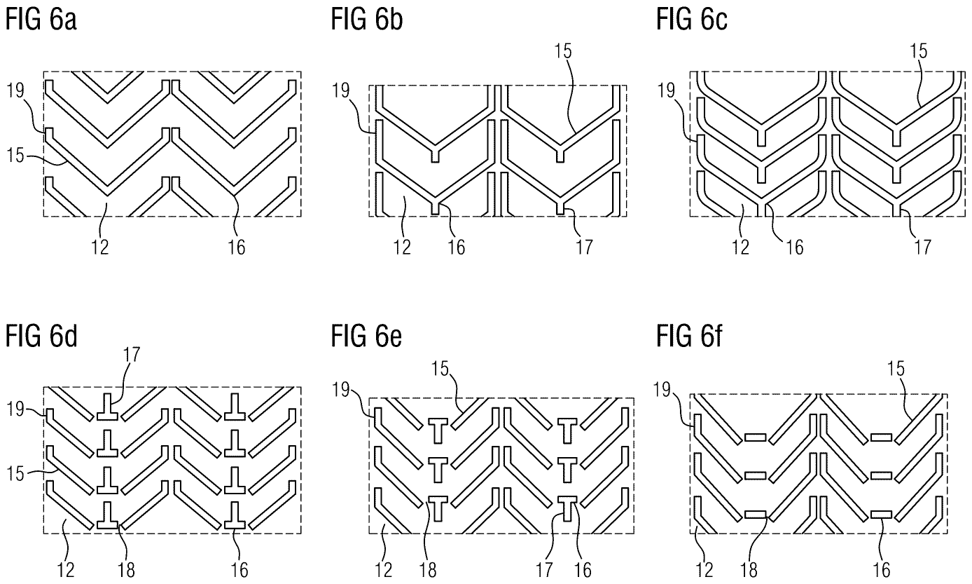

FIGS. 6a to 6f schematic plan views of various embodiments of a double-arranged profiling of a conveyor belt according to the invention;

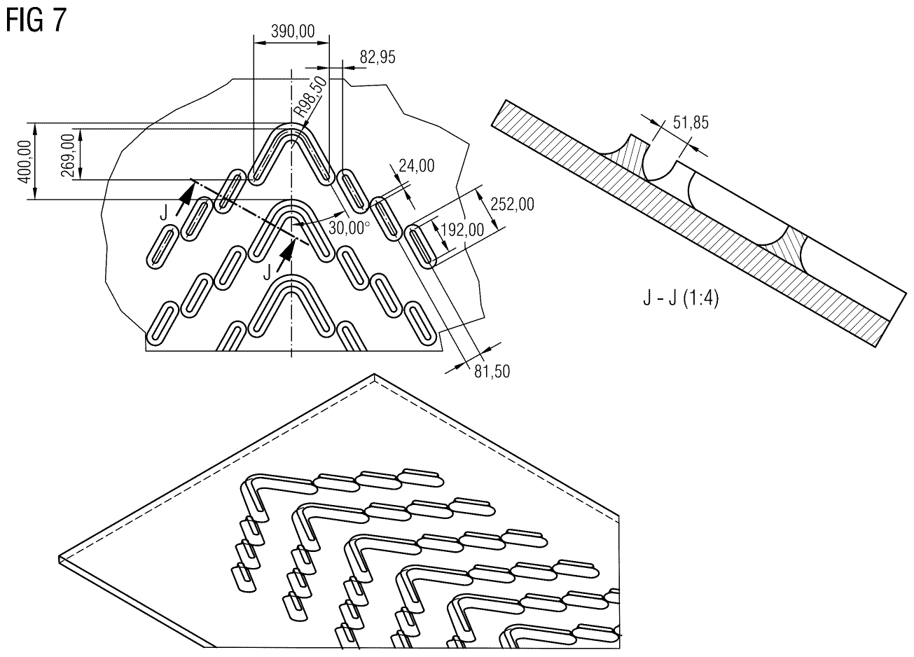

FIG. 7 a drawing and schematic plan view of the Heavy-Duty Chevron Cleat type “30-90 R32” designed for a heavy mining application.

FIG. 1 a and b shows a schematic representation of a section through a conveyor belt 1 according to the invention. The conveyor belt 1 has a belt body 10 of a width E in the transverse direction Y with a carrying side top cover 12 and a pulley side bottom cover 13. Between the two covers 12, 13, reinforcement members 11 are embedded in the belt core 11a, which extends in the longitudinal direction X and absorb the tensile forces of the conveyor belt 1. As reinforcement members 11 or tension members 11, e.g. steel cables 11 in steel cord conveyor belts 1 (e.g. in FIG. 1 a), fabric plies 11 of e.g. polyester, polyamide, cotton, polyethylene, polypropylene etc. in fabric conveyor belts 1 (e.g. in FIG. 1 b) or aramid 11 in aramid conveyor belts 1 can be used. The thickness C of the conveyor belt 1 extends in the vertical direction Z, i.e. perpendicular to the transverse direction Y and longitudinal direction X.

The top cover 12 has outer edges A, B in the width direction Y, i.e. in the direction perpendicular to the conveying direction X, which are not covered by profiling and which may also be referred to as longitudinal edge 14.

On the top cover 12, a chevron profiling 15-19 is provided, by means of which the conveyed material should be kept fixed even with larger inclination angles of, for example more than 20°. The chevron profiling 15-19 has diagonal elements 15, which are also used in chevron-cleated belts. The diagonal elements 15 are preferably formed integrally with the top cover 12. They are arranged in the region between the edge zones A, B over a width G in the transverse direction Y of the conveyor belt 1 so that they give a V-shape, the tip 16 is aligned in the longitudinal direction X against the conveying direction Q. The tip 16 is supported against the conveying direction by a longitudinal extension 17 or strengthened.

FIG. 2 shows a preferred embodiment, where the tip 16 is formed in the conveying direction Q as a semicircle to partially receive the conveyed material in the trough formed thereby and to thereby hold the same. The diagonal elements 15 have interruptions 18 so that the individual diagonal elements 15 in their entirety again give a V-shape. However, the individual diagonal elements 15 have a steeper orientation than their entirety.

FIG. 3 shows a double arranged profiling of the preferred embodiment of FIG. 2. The diagonal elements 15 extend both individually and in their entirety both in the conveying direction X and in the transverse direction Y. By this arrangement and possibly also by the interruptions 18 the diagonal elements 15 hold the conveyed material on the top cover 12. In this manner, also if the diagonal elements have a low height D the elements 15 exercise relatively large holding forces on the conveyed material. These forces can be influenced by the configuration of the diagonal elements 15 in the direction of their individual orientation, the alignment of the entirety of the bevel cams 15, their shape and height D, etc.

FIGS. 4a to 5f show schematic plan views of various further embodiments of a simply arranged profiling 15-19 of a conveyor belt 1 according to the invention.

FIGS. 6a to 6f show the corresponding views of double-arranged profiles 15-19. These in addition to the illustrations in FIGS. 2 and 3 have longitudinal extensions 19 of the diagonal elements 15 as a lateral holding element for the conveyed material.

FIG. 7 shows profiling 15-16 formed according to the design of the Heavy-Duty Chevron Cleat type “30-90 R32”, which was specifically developed for a heavy mining application. It has following parameters:
Head width: 30 mm
Base width: 90 mm
Base radius: 32 mm
Head-base transition angle: 8°.

The manufacturing process of rubber belts equipped with a rubber Chevron Cleat type “30-90 R32” is very time consuming, so the usage of TPE for a manufacturing of such massive and voluminous chevron cleats can not only increase service lifetime due to excellent physical-mechanical properties of TPE comparing to rubber, but also significantly reduces the manufacturing time via production through a casting or injection molding process.

In the following, the present invention will be further described by means of some examples, which however should not be construed a limiting the invention in any relevant manner.

### Examples

A set of belts with covers applied for thermoplastic and rubber belts without chevrons was prepared. In this set, the material used for the manufacturing of the belt cover was varied by using different thermoplastic elastomers and conventional rubbers. The respective mechanical properties of the top cover materials are provided in the following table 1:

TABLE 1

| | | Tensile | | |
|---|---|---|---|---|
| Belt cover | | strength | Elongation at | Abrasion |
| material | Material Base | [MPa]¹ | break [%]¹ | [mm³]² |
| TPE1 | TPU Ester | 57 | 570 | 16 |
| TPE2 | TPU Ether | 45 | 650 | 30 |
| TPE3 | TPV | 15 | 526 | 85 |
| Rubber 1 | NR/SBR/BR | 28 | 600 | 70 |
| Rubber 2 | NR/SBR/BR or | at least 25 | at least 450 | max. 120 |
| | NR/BR (DIN-X) | | | |
| Rubber 3 | SBR (DIN-Y) | at least 20 | at least 400 | max. 150 |
| Rubber 4 | SBR (DIN-Z) | at least 15 | at least 350 | max. 250 |
| Rubber 5 | SBR or SBR/BR | at least 18 | at least 400 | max. 90 |
| | (DIN-W) | | | |

¹determined according to DIN53504 and ISO 37: 2017;
²determined according to ISO 4649: 2017 Method A.
Test specimen: as required in the standard with smooth surface.

As can be seen from table 1, the TPE materials provide comparable tensile strength and elongation, but significantly better abrasion characteristics compared to the conventional rubber materials. This translates into a longer service lifetime of a respective belt top cover and the entire conveyor belt in standard environmental conditions. In the above table, the rubbers 2 and 3 correspond to the most commonly used rubber grades (DIN-X and DIN-Y) for belt covers in mining and heavy industrial applications.

In the next step conveyor belt samples with respective covers were prepared and investigated for the impact energy, which inflicts a first damage to the top belt cover. The testing was performed by dropping a weight of 150 kg on different belt samples having a carcass comprising 1 to 4-plys of fabric reinforcement with the nominal breaking strength of 1000 N/mm (Newton per mm width) with and without breaker in the top cover, which were pre-tensioned in a test rig at the 10% of the nominal breaking strength. The impact head used for the test had a diameter of 25 mm and the form of a hemisphere at its tip.

The belts investigated in this test, the respective top cover thickness and the impact energy until a first damage is provided in the below table 2.

TABLE 2

| | | | Impact energy |
|---|---|---|---|
| | | Top Cover | with a first |
| | Material Base of | Thickness | damage of the |
| Belt type | the Top Cover | [mm] | belt top cover [J] |
| NG¹ 1000/1 2/2 TPE | TPU Ester | 2 | 441 |
| EPP² 1000/2 15/5 DIN-W | SBR | 15 | 735 |
| EPP² 1000/2 8/3 DIN-W | SBR/BR | 8 | 367 |
| EPP² 1000/2 8/3 DIN-Y | SBR | 8 | 294 |
| EP³ 1000/4 + 2 5/2/2 DIN-X with | NR/SBR/BR or | 5 | 294 |
| an additional 2 mm-fabric | NR/BR | | |
| breaker under the top cover | | | |
| EP³ 1000/4 + 2 8/4 DIN-X with | NR/SBR/BR or | 8 | 367 |
| an additional 2 mm-fabric | NR/BR | | |
| breaker under the top cover | | | |
| EP³ 1000/4 + 2 6/2 DIN-X with | NR/SBR/BR or | 6 | 367 |
| an additional 2 mm-fabric | NR/BR | | |
| breaker under the top cover | | | |

¹NG = “NextGen”-reinforcement; special high strength straight-warp woven fabric carcass, which comprises yarns made of ultra-high molecular weighted polyethylene UHMW-PE and polypropylene PP;
²EPP stands for a belt with reinforcing fabric having polyester warp threads in the direction of the belt travel, and polyamide weft threads. The two thread types are bound together by an additional polyamide binder yarn. In 1000/2, 1000 indicates the breaking strength of the belt (1000 N/mm) and “2” indicates the number of reinforcing fabric plies.
³EP stands for the same belt design as in 2, but without the additional polyester binder yarn.

As can be seen in table 2, (with the exception of the Epp 1000/2 15/5 DIN-W belt), all belts provided a comparable impact energy until a first damage of the top cover of about 400 J. However, the thickness of the belts top cover to provide this impact energy significantly varies over the belts, with the inventive TPE-belt having a top cover thickness over only 2 mm, whereas the conventional rubber belts had a thickness of at least 5 mm, which results in a significantly higher weight of the belt. As further becomes apparent from the 2^{nd} and 3^{rd} samples in the table, the impact energy increases on increasing the thickness of the cover, which as noted however is at the expense of a higher weight. The impact energy with a first damage of the belt top cover in the belts is correlated to the service lifetime of the top cover and of an entire conveyor belt, in that a higher impact energy value provides a belt with a higher durability.

In a further test, the coefficient of friction and the cleanability was determined for a further set of belts covers using different rubbers and TPEs in the top cover. The cleanability was tested according to a Clay Cleanability test as follows:

Test specimen with a thickness of 2 mm and a surface of 50 mm×75 mm are assembled in the inner side of a tumbling container with an volume of 4 dm³. Wet or dry clay is added to the container and the container is than rotated for 15 min during which the specimen are regularly fully covered with the test medium. After the tumbling treatment, the specimen are cleaned with a rubber scraper for dry clay or a plastic scraper for wet clay. After cleaning, the cleanliness of the specimen is rated relatively to other samples on a scale from 1 to 5, where a rating 5 is equivalent to high density polyethylene film.

The results of the respective tests are provided in the following table 3.

TABLE 3

| | | | Cleanability Test |
|---|---|---|---|
| Belt Cover | Material | | Rating (“0” → very |
| Material | Base | COF¹ | bad - “5” → excellent) |
| TPE 1 | TPU Ester | 0.65 | 3.0 |
| TPE 2 | TPU Ether | 0.57 | 5.0 |
| TPE 3 | TPV | 0.33 | 4.5 |
| Rubber 1 | NR/SBR/BR | 1.82 | 0.7 |
| Rubber 2 | EPDM | 0.68 | 2.0 |

¹= measured close to ASTM D1894-2014 (Standard Test Method for Static and Kinetic Coefficients of Friction of Plastic Film and Sheeting) with difference in sample size and weight. The weight used was 2268 g at a sled weight of 100 g and a COF block weight of 120 g; the block had dimensions of 95.25 × 95.25 × 12.75 mm; the approximate pressure was 2687.5 N/m².

From the results of the COF- and cleanability tests presented in table 3 it becomes apparent, that the belt covers made of TPE-materials not only have excellent cleanability compared to the rubber grades, but also in most cases had a lower value of COF, which enables to use of the TPEs for a bottom cover of low rolling resistant conveyor belts applied in long-distance overland belt conveyors.

Further exemplary belt profiles and parameters for conveyor belts according to the invention are given in the following table 4:

### REFERENCE SIGNS

A First edge zone
B Second edge zone
C Thickness of the belt
D Height of the profiling
E Width of the belt
G Breadth of the profiling
Q conveying direction
X longitudinal direction
Y transverse direction
Z vertical direction
1 conveyor belt
10 belt body
11 reinforcement members
11a belt body
12 carrying side top cover
13 pulley side bottom cover
14 boundary area
15 diagonal element
16 tip of the profiling
17 extension of the tip
18 interruption of the diagonal elements 15
19 extension of the diagonal elements 15
30 transverse reinforcement (not in figures yet)

1. A Conveyor belt, with a top cover on the carrying side and a bottom cover on the pulley side, wherein the layers comprise an elastomeric material and the conveyor belt further comprises a belt body having one or more embedded reinforcement members, wherein the conveyor belt on its top cover has a profiling, which is formed substantially perpendicular to the carrying-side top cover, wherein the profiling is a chevron profiling that has diagonal elements that extend both in the longitudinal direction and in transverse direction of the conveyor belt and which together form a V-shape in pairs, wherein the top cover on the carrying side and the chevron profiling is formed from a thermoplastic elastomer.

2. The Conveyor belt according to claim 1, wherein the height of the chevron profiling is more than 10 mm and preferably in the range of from 20 to 50 mm.

3. The Conveyor belt according to claim 1, wherein the thermoplastic elastomer is selected from a thermoplastic polyurethane and a thermoplastic vulcanisate.

4. The Conveyor belt according to claim 3, wherein the thermoplastic polyurethane is based on a polyether, preferably polytetramethylene glycol, or polyester polyol, preferably an adipate-based polyester polyol or an polycaprolactone-based polyester polyol, as the polyol component.

5. The Conveyor belt according to claim 3, wherein the thermoplastic polyurethane is based on an aromatic polyisocyanate, preferably selected from toluene diisocyanate or methylene diisocyanate.

6. The Conveyor belt according to claim 3, wherein the thermoplastic vulcanisate is based on a dynamically vulcanized mixture comprising ethylene-propylene-diene rubber and polypropylene.

7. The Conveyor belt according to claim 1, wherein the chevron profiling covers at least 50% and preferably from 70 to 95% of the width of the belt.

8. The Conveyor belt according to claim 1, wherein the top cover on the carrying side and a bottom cover on the pulley side are formed from the same material.

9. The Conveyor belt according to claim 1, wherein the conveyor belt further has at least one transverse reinforcement.

10. The Conveyor belt according to claim 1, wherein the chevron profiling is formed as part of the top cover.

11. The Conveyor belt according to claim 1, wherein the chevron profiling is shaped in accordance with the cleat type 30-90 R32 and has the following parameters:
Head width: 30 mm
Base width: 90 mm
Base radius: 32 mm
Head-base transition angle: 8°.

12. A Method for the production of a conveyor belt according to claim 1, wherein the method comprises the steps of:
i) providing one or more reinforcement members;
ii) embedding the one or more reinforcement members in a belt core;
iii) applying a top cover on one side of the belt core;
iv) applying a bottom cover on the other side of the belt core;
wherein the top cover are prepared with a chevron profiling and at least the top cover or a part of it and the chevron profiling are formed from a thermoplastic elastomer.

13-15. (canceled)

16. A Conveyor belt system comprising at least one drive pulley with a motor, one deflecting pulley and a conveyor belt according to claim 1.
